(19) United States
(12) Patent Application Publication
(10) Pub. No.: US 2006/0224682 A1
(43) Pub. Date: Oct. 5, 2006

(54) System and method of screening unstructured messages and communications

(75) Inventor: William H. Inmon, Castle Rock, CO (US)

Correspondence Address: Chad R. Walsh;Fountainhead Law Group, Suite 509, 900 Lafayette St., Santa Clara, CA, 95050, US

(73) Assignee: Inmon Data Systems, Inc., Castle Rock, CO (US)

(21) Appl. No.: 11/397,593

(22) Filed: Apr. 3, 2006

Related U.S. Application Data
(60) Provisional application No. 60/668,011, filed on Apr. 4, 2005.

(51) Int. Cl. G06F 15/16

(52) U.S. Cl. 709/206

(57) ABSTRACT

Embodiments of the present invention include a system and method of screening unstructured messages and communications. In one embodiment, messages and communications may be received in the form of email and telephone transcripts. In one embodiment, the present invention includes a method of extracting text from email and telephone transcripts and screening the content of the messages in order to pick out useful and relevant information using a list of words and phrases that can be described as industry recognized words and phrases. Industry recognized words and phrases are matched against the contents of the messages and communications to determine what part of the message or communication is relevant to an aspect of business.

### CROSS REFERENCE TO RELATED APPLICATIONS

This invention claims the benefit of priority from U.S. Provisional Application No. 60/668,011 filed Apr. 4, 2005, entitled “System and Method of Screening Unstructured Messages and Communications”.

### BACKGROUND

The present invention relates to unstructured data processing, and in particular, to systems and methods of screening unstructured messages and communications.

Unless otherwise indicated herein, the approaches described in this section are not necessarily all prior art to the claims in this application and are not admitted to be prior art by inclusion in this section.

The world of information technology can be divided into two environments—unstructured data and processing and structured data and processing. The structured world is a world of databases, transactions, records, data layouts, reports and the like. Structured data processing consists of business transactions, usually involving money. For example, ATM activities, airlines reservations, insurance premium processing, inventory management are all standard forms of structured data and processing. The unstructured world is a world of spreadsheets, emails, telephone conversation transcripts, documents, and text. Unstructured data and processing are those activities—usually messages and communications—that occur inside the corporation that are unbound by records, form, or content. An unstructured activity has no predetermined limitations on it.

It has been recognized that these worlds exist separate and apart. Technology either fits into one world or the other. There is very little crossover technology between the two worlds. But there are major opportunities waiting for technology that crosses the bridge between the structured world and the unstructured world.

For years unstructured data has been collecting and passing through organizations. The unstructured data takes the form of messages and communications. Typically, the sources of unstructured messages and communications are email and transcribed phone conversations. Once into a textual format, these messages and communications stay within the boundaries of unstructured data.

But there are great possibilities for exploitation if those messages and communications were to be intersected with structured data. Unfortunately the lack of structure, the lack of format, and the lack of familiar and manageable content makes it difficult, if not impossible, to blend structured data with the unstructured messages and communications. For example, the content of unstructured communications typically has no format, no structure, no limitations. The message or communication can be long or short. The message can be in English, Russian, or any other language. The communication can be in sentences or prose. In short there is no structure, format or limitation on unstructured communications. What is needed is a means of relating the two worlds.

The common link between the two worlds of structured data and unstructured data is text. But text is used so differently in the two environments that merely matching text causes even more confusion. In order to make sense of text that can be used for linking the worlds of structured data and unstructured data, it is necessary to be able to look at the unstructured messages and communications and pluck out of that environment the text that is meaningful to other environments, such as the structured environment.

The lack of structure found in messages and communications presents a profound barrier to the use of unstructured data—messages and communications—in the context of business. Because of the lack of structure, classical structured techniques of organizing and accessing data into transactions, records, and databases do not work. In order to start to use unstructured messages and communications in the structured world, some special processing must be done against the unstructured data—messages and communications—to make the data fit for processing in the structured environment.

When it comes to messages and communications, merely placing messages and communications in the structured environment is a wasteful and ineffective thing to do. When messages and communications are placed into the structured environment, there are several problems. First, messages and communications take up huge amounts of space. The amount of bulk consumed by messages and communications makes them expensive to handle and awkward to process. Second, many of the messages and communications are not relevant to the business or organization and typically such messages are not useful for making business decisions, yet they still take up space and must be handled. Additionally, most parts of the messages and communications that do relate to the business are not directly useful. Yet the entire message must be stored, which is wasteful and causes inefficient processing.

FIG. 1 shows how an organization has merely placed unstructured messages and communications in the structured environment. The result might be messages and communications in the structured environment such as the message depicted in 100 stored in database 110, wherein the pieces of information span the realms of both personal and business information. These messages and communications are hard to analyze or index, as these messages can be about anything. There may be massive amounts of data placed into the structured environment that have nothing to do with any aspect of business. About the only way to make sense of these messages is to read each message or communication in its entirety. Given that there may be many, many messages such an approach is not practical.

Most of the messages and communications do not have anything to do with business. And for those messages and communications that do have something to do with business, the information is disorganized and difficult to find. To find something of importance requires a scan through all of the documents. When there are only 30 or 40 documents, such a scan is only a bother. But when there are tens of thousands or more documents, a manual scan becomes a truly arduous task and becomes very impractical.

Thus, what is needed is a method of screening unstructured business data in a way that will improve the efficiency, speed and quality of information available for making business decisions while also reduce the cost to store and process such data. The present invention solves these and other problems by providing an efficient information screening method that may be used to transfer unstructured messages and communications into the structured world.

### SUMMARY

The present invention pertains to a method of screening unstructured messages and communications. Features and advantages of the present invention include separating useful information (e.g., for a business or enterprise) in messages and communications from unuseful information (i.e., blather). Embodiments of the present invention may determine which part of the messages and communications are relevant to the business and classify the business relevant messages and communications as to what business subjects they are relevant to.

By analyzing messages and communications, the unnecessary blather can be discarded, and only the relevant business terms can be sent to the structured environment. This greatly reduces the need for storing unnecessary data in the structured environment and greatly speeds processing in that only relevant and useful terms are stored in the structured environment.

In one embodiment, text captured from email and telephone transcripts is screened and the content of the messages is categorized in order to pick out useful and relevant information using a list of words and phrases of described as industry recognized words and phrases. The industry recognized words and phrases are matched against the contents of the messages and communications to determine what parts of the message or communication are relevant to an aspect of business.

In one embodiment, in order to make an industrial recognition approach work, it is necessary to have a list of industry used terms. There are industrial categories and within those categories there are terms that belong to those categories. Typical categories might be accounting, finance, human resources, compliance, ethics, and so forth.

In one embodiment, the words and phrases of each message and communication are passed through a screening program. The screening program looks at each word or phrase and attempts to match the word or phrase form the message or communication with the words and phrases found in the industrial lists. When a match is made, also called “a hit”, a record is written for the match.

In one embodiment, at the end of the screening process, messages and communications can be divided into one of two classes—useless and useful communications (e.g., relevant or irrelevant to a business).

In one embodiment, the business useful messages and communications can be further divided into different classes based on the relevance of the message or communication to industry categories. In other words, a message can be deemed to be relevant to accounting and finance, but not human resources and sales.

In one embodiment, once the messages and communications are screened, they can then be linked to structured data, or they can be further processed based on the results of the screening that has been done.

In one embodiment, the present invention includes a method of converting unstructured data into structured data comprising reading unstructured text based data, comparing said unstructured text based data against a predefined list of terms, and generating one or more structured records if a term in the text based data matches a term in the predefined list.

In one embodiment, the unstructured text based data comprises a plurality of text messages or communications, and the method further comprises automatically deleting a message or communication if a term in the predefined list does not match any term in the message or communication.

In one embodiment, the method further comprises storing the one or more records in a database.

In one embodiment, the text based data are a plurality of emails.

In one embodiment, the method further comprises converting audio to text based data.

In one embodiment, terms in the text based data are compared against each term in the predefined list.

In one embodiment, a match occurs if the term in the text based data is an exact match with the term in the predefined list.

In one embodiment, a match occurs if the term in the text based data is a stemmed match with the term in the predefined list.

In one embodiment, the predefined list includes categories.

In one embodiment, the method further comprises grouping records by categories in the predefined list.

In one embodiment, the predefined list includes subcategories.

In one embodiment, the method further comprises grouping records by subcategories in the predefined list.

In one embodiment, a record is generated for each match.

In one embodiment, one record is generated for a plurality of matches.

In one embodiment, the method further comprises associating at least one record with the text based data.

In one embodiment, the method further comprises associating at least one record with particular portions of text based data.

In one embodiment, the method further comprises storing at least one record and a link to the text based data in a database.

In one embodiment, the method further comprises calculating the relevance of the text based data. In one embodiment, calculating comprises counting the number of occurrences of a term from the predefined list in the text based data.

In one embodiment, the categories include finance, accounting, or sales.

In another embodiment, the present invention includes a method of converting unstructured data into structured data comprising reading a plurality of unstructured text messages or communications, comparing said plurality of unstructured text messages or communications against a predefined list of terms, generating a structured record if a term in a particular text message or communication matches a term in the predefined list, and deleting the particular text message or communication if a term in the predefined list does not match any term in the particular text message or communication, and storing the records in a database. In one embodiment the predefined list includes categories of terms, and wherein the method further comprises grouping the records by the categories in the predefined list.

In another embodiment, the method may include associating each generated record with the particular text message or communication.

These and other features of the present invention are detailed in the following drawings and related description.

### BRIEF DESCRIPTION OF THE DRAWINGS

FIG. 1 illustrates how merely storing unstructured messages and communications in structured environments wasteful and inefficient.

FIG. 2 illustrates how industrial recognition may be used for screening and organizing unstructured message and communication data according to one embodiment of the present invention.

FIG. 3 illustrates the general flow of the screening process according one embodiment of the current invention.

FIG. 4 shows two typical configurations of the output from the screening process according one embodiment of the present invention.

FIG. 5 shows a sampling of industry-recognized categories according one embodiment of the current invention.

FIG. 6 shows that for an industrial category, words and phrases that are commonly used in that category are collected according one embodiment of the current invention.

FIG. 7 illustrates the separation of useful from useless information according one embodiment of the current invention.

FIG. 8 illustrates an alternative way of looking at the effect of screening raw text according one embodiment of the current invention.

FIG. 9 illustrates how after the hits have been determined that the hits can be grouped according one embodiment of the current invention.

FIG. 10 illustrates the overall screening process using industry recognized terms and words according one embodiment of the current invention.

FIG. 11 illustrates an alternative use of the screening process according to one embodiment of the present invention.

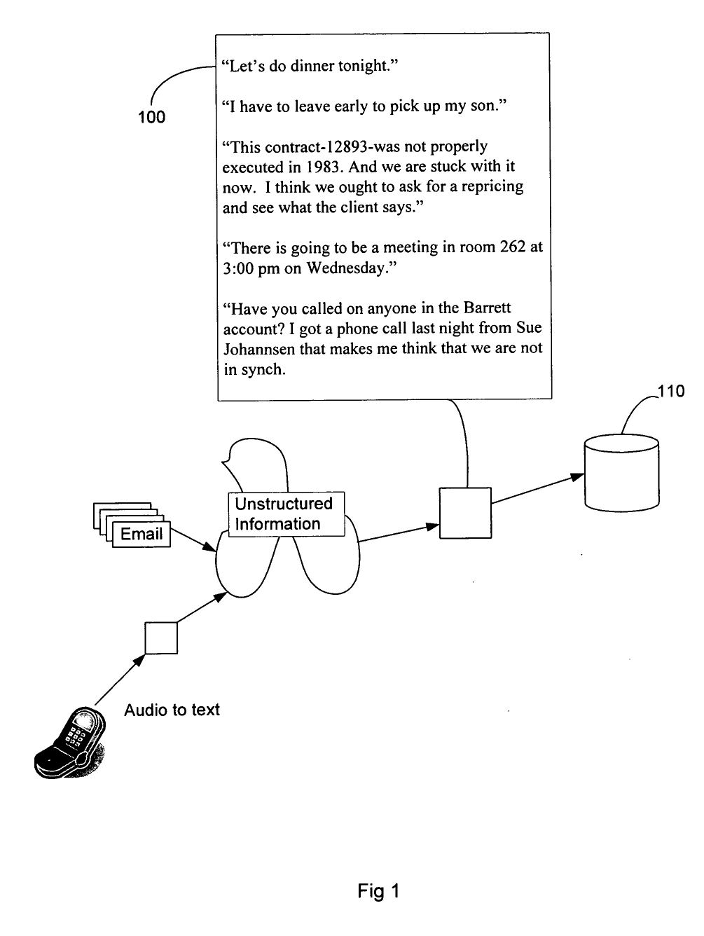

### DETAILED DESCRIPTION

Described herein are systems and methods of screening unstructured messages and communications. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments of the present invention allow unstructured messages and communications to be read and then to have meaningful terms (i.e., words and phrases) extracted out of the content of the text. In doing so messages and communications can be sorted into two classifications—messages and communications which are not useful for business processing—sometimes called “blather,” and messages and communications that are useful for further processing in the context of business.

To make unstructured data useful for business purposes, it is necessary to separate messages and communication containing useful information from messages and communication with absolutely no useful information. Then, to save storage space and provide for efficient use of the information, the useful parts of the messages and communications should be filtered out and classified by what business subjects to which they are relevant. Currently there is no efficient and cost effective system for sorting data from unstructured data sources, which means there are huge banks of data unavailable for making business decisions.

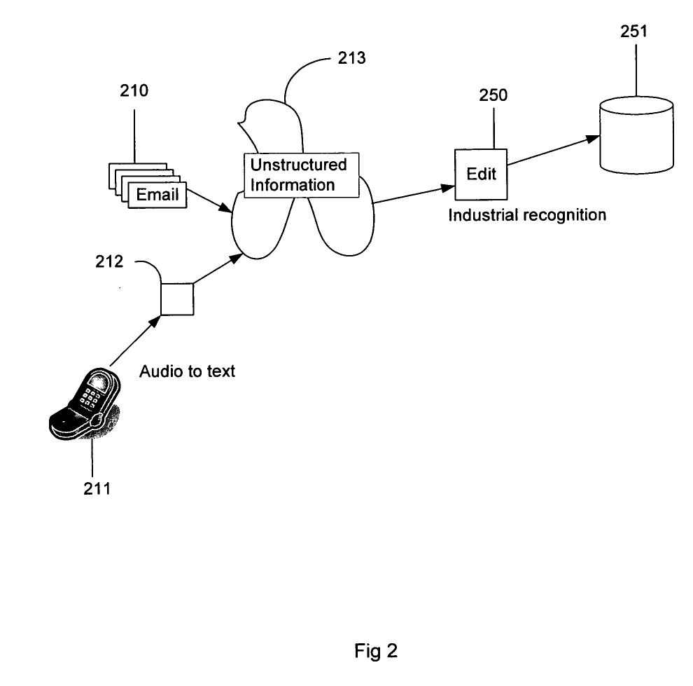

FIG. 2 illustrates how industrial recognition may be used for screening and organizing unstructured message and communication data according to one embodiment of the present invention. In one embodiment, industrial recognition of terms (i.e., words and phrases) in the message or communications is used to extract useful information. This may be regarded as an “ontological” approach to the screening of messages and communications. In the example of FIG. 2, email 210 and audio, for example from a cell phone 211, may be transcribed by audio to text component 212 (e.g., which may be hardware, software, or a combination of hardware and software) to generate unstructured information 213. It is to be understood that text messages or communications may be received from a variety of other sources including cell phone text messages, for example. However, according to one embodiment of the present invention, the unstructured data 213 may be processed by a program 250 that applies industrial recognition to the data to extract relevant information. Program 250 may generate a structured output that may be stored in database 251, for example. Industrial recognition is the process of applying information that is known to be relevant to the incoming data, and extracting relevant data based on the result. For example, an industrial recognition program may include a list of terms known to be relevant to a particular business. The relevant data may be extracted based on whether or not one or more of the terms in the list is included. It is to be understood that a variety of complex extraction procedures or algorithms may be used in this process. Generally, one aspect of this invention is the recognition that unstructured messages and communications may be transferred into the structured world by applying information known to be relevant to a particular business.

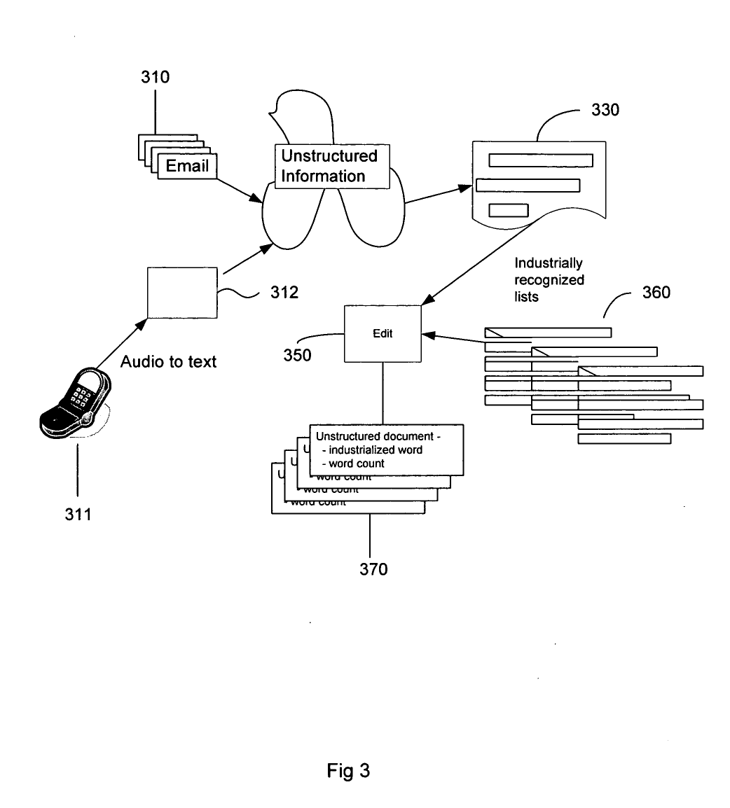

FIG. 3 illustrates the general flow of data and processing of terms (words or phrases). FIG. 3 shows that email 310 or phone messages 311 may be collected. The phone messages begin as audio messages and are converted into text by audio to text component 312. Once converted into text, the phone messages are collected along with the email messages. At this point both the email messages and the phone messages exist as unstructured raw text 330. The raw text is then passed through a screening program 350, which may be referred to generally as an industrial recognition screen (e.g. the “edit” screen shown in the FIG. 3). The industrial recognition of words and phrases screen uses one or more predefined lists 360 of industry recognized terms (i.e., words or phrases) to screen the raw text. Each word or phrase in the raw text is passed against each word or phrase in the industry recognized lists. At the end of the screening process, every time a “hit” has occurred, a record 370 may be created. A “hit” is made when there is a match between a word or phrase from the raw text and the same word or phrase from the industry recognized word list. Records 370 may, in turn, be stored in a database, and the database may be queried to access the records. Furthermore, as described in more detail below, the records may be associated with the unstructured data (e.g., a record may be associated with an email that resulted in creation of the record). For example, records 370 may be stored in a database with links to the text based data. Accordingly, accessing structured information and/or associated unstructured information may be done through the structured environment.

In one embodiment, a hit can be made on a literal word or a stemmed word. A literal word is an exact match. Take for example the literal word “moving”. A literal match of the words looks exactly for “moving”. A stemmed match looks for a match between word stems. For example, in a stemmed search suppose the raw text has the word “moving”. If the industry recognized list had the word “mover”, there would be a match because both “moving” and “mover” have the same word stem—“move”. In one embodiment, the matching done in the screening process shown in FIG. 3 can be done either literally or on a stemmed basis.

In one embodiment, one or more lists of industry recognized words and phrases can be used in the screening process. For example, a screen may use lists such as an accounting list, a finance list, a sales list, and a human resources list.

In one embodiment, the same word may appear in more than one industry recognized list. For example the word “account” may be found in the accounting list, the sales list, and the finance list.

The output record is simple. The output record may include a variety of different fields of data, including but not limited to, raw text identifier, raw text date, time, type of match, term matched, or an industry recognized category, for example. Each word or phrase in the industry recognized list may have a category. Typical categories include, but are not limited to, accounting, sales, engineering, and compliance, for example.

An example industry recognized list for accounting includes, but is not limited to, phrases such as payable, receivable, amount due, due date, interest, chart of accounts, account name and activity date.

Output from the processing of raw messages and communications passing through the screen in FIG. 3 might be as follows:

email 1244098

email date—May 13, 2003

literal match

“amount due”

category accounting

In one embodiment, a hit will be generated for every occurrence of the hit word in a single email. In one embodiment, an output record would be produced every time a hit is made. In one embodiment, not only can words be processed, but multiple words can also be processed. For example, the screen may look for single words (e.g., “payable”), phrases (e.g., “due date”) or various combinations thereof. There is no limitation on the size of the phrase or the number of words in the phrase.

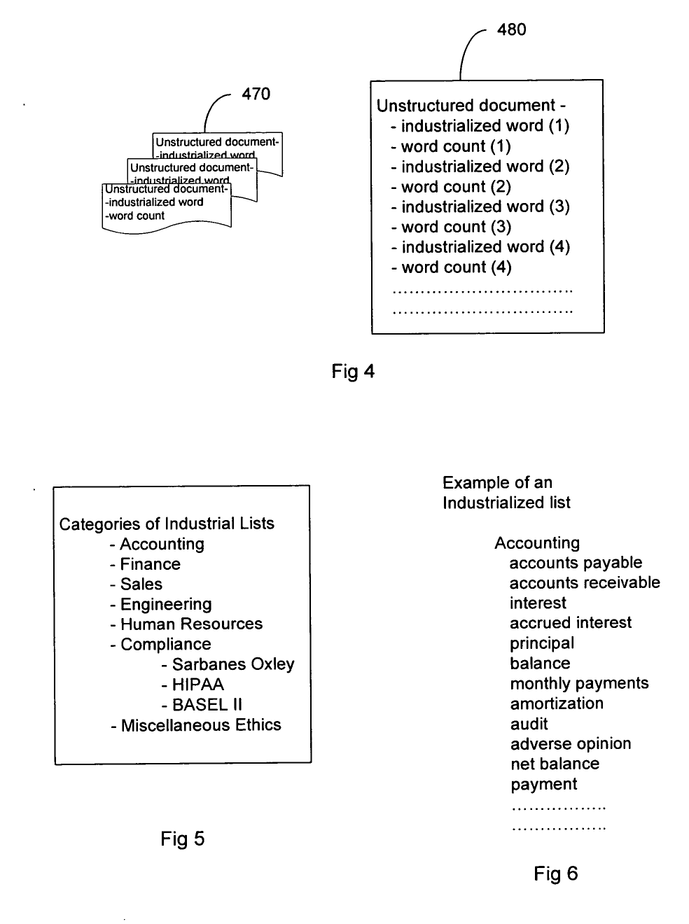

The output from the screen can be physically configured in several ways. FIG. 4 shows two of the ways the output can be configured. In FIG. 4 it is shown that there are individual physical records 470 for each hit made by the screen. Alternatively, the data can be grouped in a single record 480. Record 480 in FIG. 4 shows a raw text document that results in multiple hits. The record for such a screening activity might look like the following:

Phone call: AJK776-198

Phone date: Mar. 14, 2005

Literal match: “the Jones account”

Category: accounting

Stem match: “transfer”

Category: sales

Literal match: “contingency sale”

Category: compliance

Stem match: “savings”

Sales

. . .

. . .

In one embodiment, the output is the same whether the records are created individually or whether the records are “batched” or grouped together.

FIG. 5 shows a sampling of the industry recognized categories. In one embodiment, within each category there may be subcategories. For example, for sales, there may be subcategories such as:

sales for ranching

sales for road moving equipment

sales for sausage makers

sales for high tech

sales for drafting and graphic design, and so forth

In one embodiment, each industrial category there will be words that are found in that category, such as seen in FIG. 6. FIG. 6 illustrates that words and phrases that are commonly used in an industrial category may be collected.

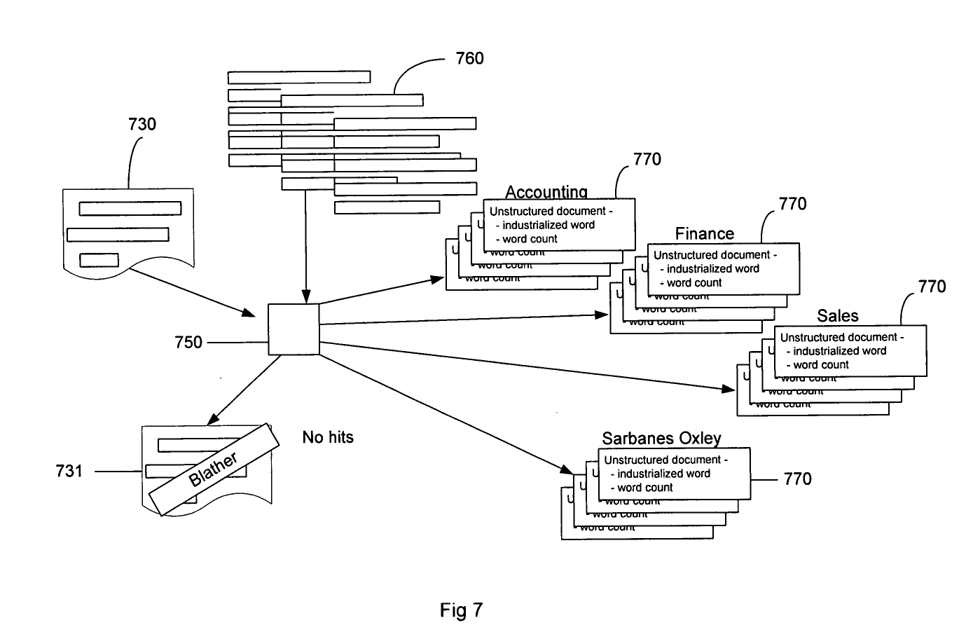

Embodiments of the present invention may be used to screen raw text to determine what messages and communications are blather and which messages and communications have real or potential business value. Blather is a message or communication that has no business value based on the content of the text of the message or communication. FIG. 7 shows such a separation.

FIG. 7 shows that raw messages and text 730 that have no hits on their text when screened against the lists of industry recognized words and phrases are considered to be blather 731. For example, an email containing only the message:
“Let's do lunch”
   has no business context in the normal sense. But the phone message:
“I found the record for the Jones account. It was for Mar. 23, 2002 and was for $3,087.26 and was written by Mary Hastings. I am going to forward the transcript of the transaction to you.”
   will probably have real business value.

The screening program 750 would not pick up any words of interest in the email and would thus classify the email as blather. The screening program 750 may match up words and phrases from the phone conversation with words or phrases on a list 760, and may show that the phone conversation would have business value. In this case, the email would be considered to be blather and the phone conversation may be used to generate one or more records or categories of records 770.

In one embodiment, once blather has been identified, it can be removed (i.e., deleted) from the email or telephone conversation data set. The result is a much smaller set of messages and emails that is much easier to handle than a larger set.

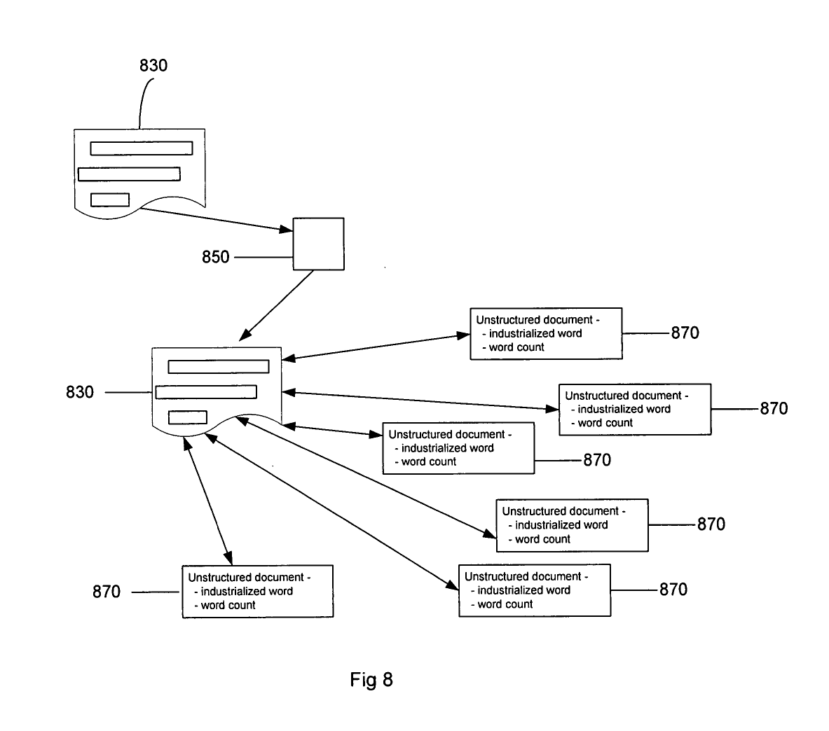

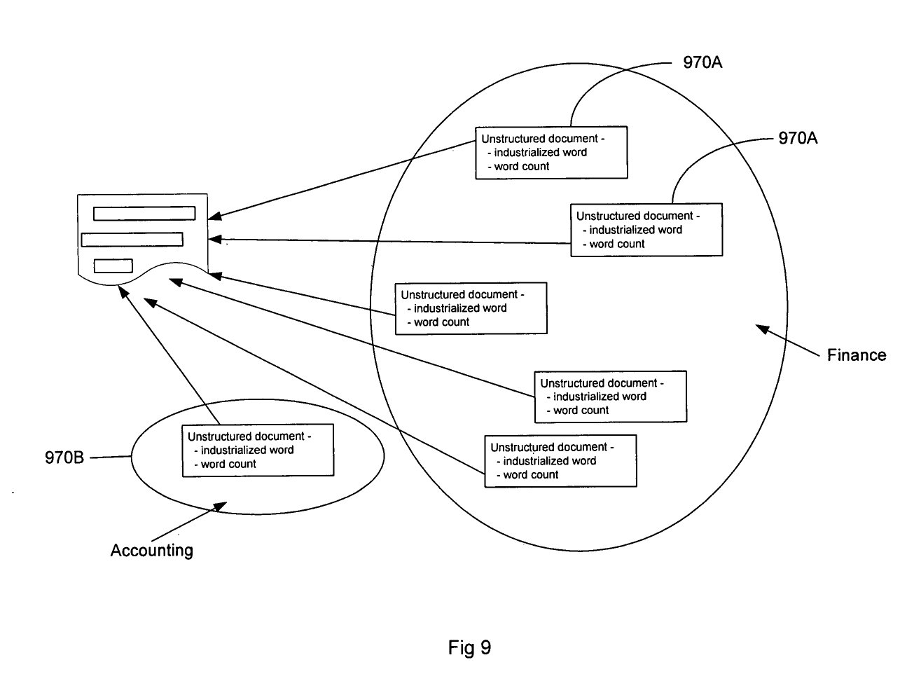

Another embodiment of screening raw text is shown by FIG. 8. In FIG. 8 it is seen that raw text 830 enters the screening program 850, that the screening program examines each word and phrase in the raw text, that hits are found, and records 870 are generated. In this example, the records may be “assigned” to, or “associated with” the raw text or particular portions of the raw text. The hits that have been made can then be grouped, as seen in FIG. 9.

FIG. 9 shows that after the hits have been determined that the records can be grouped. In the case of the example in FIG. 9, most hits are from finance and one hit is from accounting. By merely adding up the hits, a primary assignment can be made for the raw text. It can be inferred that the raw message or communication had a serious business relevance to finance, a slight business relevance to accounting, and no business relevance to such categories as sales and engineering.

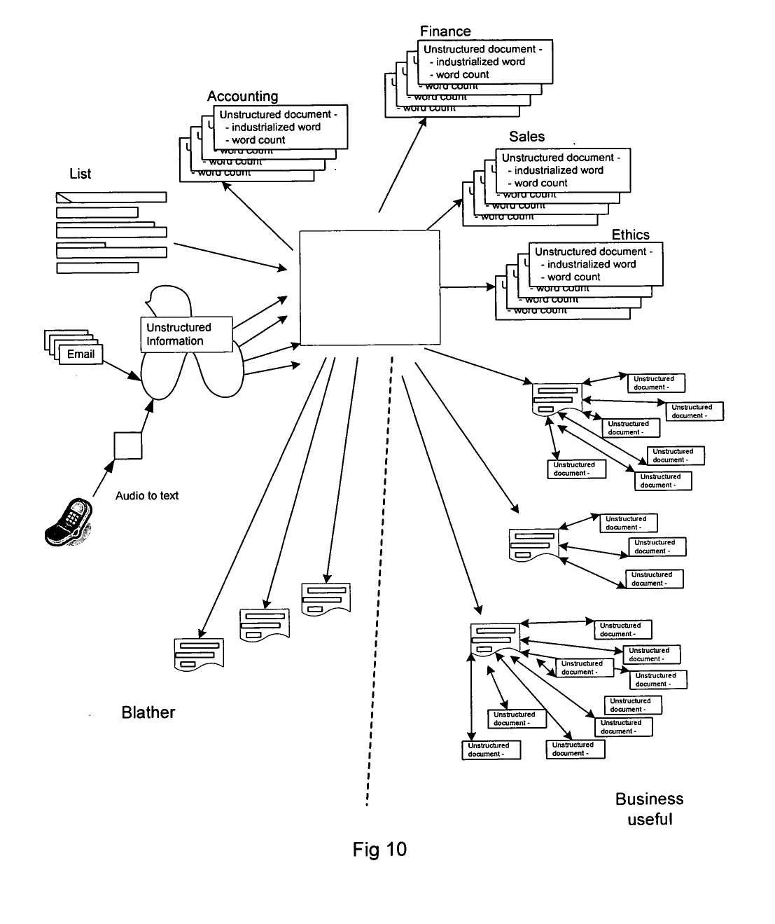

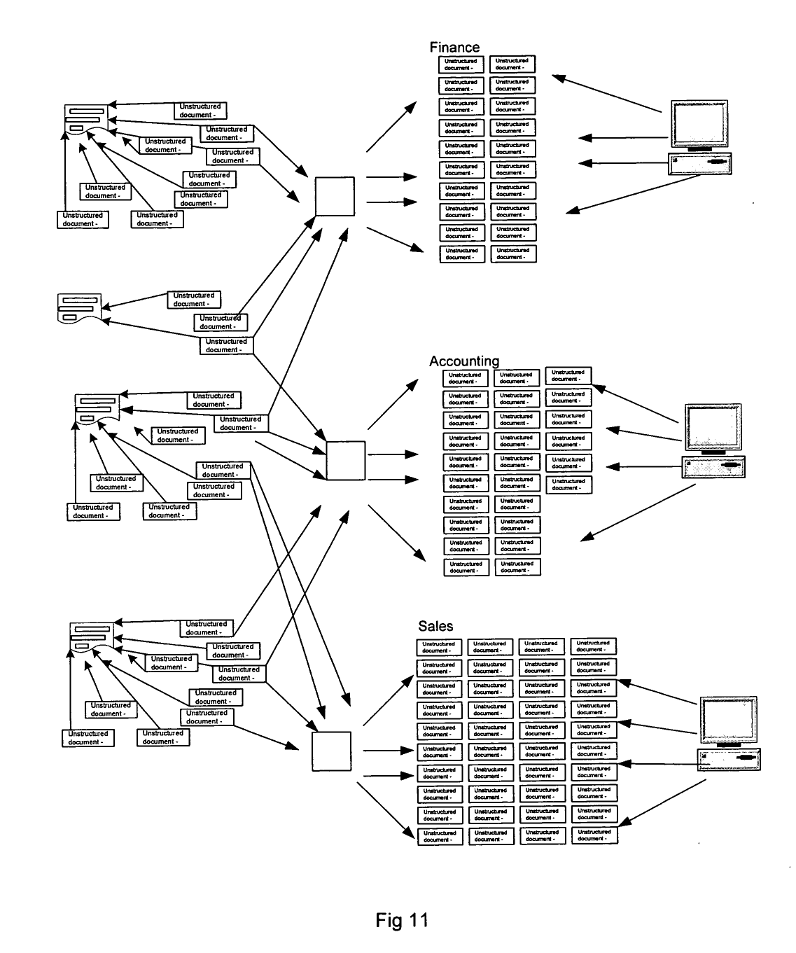

The larger picture of the screening process using industry recognized terms and words (ontologies) is shown by FIG. 10.

In one embodiment, by using the screening process and the industry recognized words and phrases, the organization can separate messages and communications into different categories; blather, useless to the business, business useful and relevant words and phrases.

Another use of the screening process is shown in FIG. 11.

In one embodiment, after the raw text has been screened, that the hits can be grouped by category or by message. Grouping by message may include grouping records by terms in the list, message type (e.g., email or audio), date, time, number of hits, etc. Grouping by category may include grouping by categories or subcategories, for example. Accordingly, the accounting organization can quickly and easily find all the messages and communications that are relevant to them, the finance people can find their messages and communications, and so forth.

In one embodiment, there is another use for the information gained in the screening process. That use is to not only tell what business subjects the message or communication is relevant to, but to calculate how relevant the message or communication is. For example, suppose it is found that a message or communication is relevant to both accounting and to finance. It is seen that there are thirteen references to accounting in the message or communication and only one reference to finance. From this it can be inferred that the message or communication is more relevant to accounting than to finance.

In one embodiment, it is useful to count the number of occurrences of a business relevant term in the message or communication. For example, suppose a message or communication has the word “account” occurring five times. Only one business reference term record need be written out. But the fact that the word or phrase occurred multiple times can also be recorded. When the calculation is made as to how relevant a message or communication is to a business subject, the number of occurrences of a word or phrase is factored in as well as the number of different words or phrases were found in the message or communication.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, information retrieval methods according to the present invention may include some or all of the innovative features described above. Based on the above disclosure and the following claims, other arrangements, embodiments, implementations and equivalents will be evident to those skilled in the art and may be employed without departing from the spirit and scope of the invention as defined by the claims.

What is claimed is:

1. A method of converting unstructured data into structured data comprising:
reading unstructured text based data;
comparing said unstructured text based data against a predefined list of terms; and
generating one or more structured records if a term in the text based data matches a term in the predefined list.

2. The method of claim 1 wherein the unstructured text based data comprises a plurality of text messages or communications, and wherein the method further comprises automatically deleting a message or communication if a term in the predefined list does not match any term in the message or communication.

3. The method of claim 1 further comprising storing the one or more records in a database.

4. The method of claim 1 wherein the text based data are a plurality of emails.

5. The method of claim 1 further comprising converting audio to text based data.

6. The method of claim 1 wherein terms in the text based data are compared against each term in the predefined list.

7. The method of claim 1 wherein a match occurs if the term in the text based data is an exact match with the term in the predefined list.

8. The method of claim 1 wherein a match occurs if the term in the text based data is a stemmed match with the term in the predefined list.

9. The method of claim 1 wherein the predefined list includes one or more categories.

10. The method of claim 9 further comprising grouping records by categories in the predefined list.

11. The method of claim 9 wherein the predefined list includes one or more subcategories.

12. The method of claim 11 further comprising grouping records by subcategories in the predefined list.

13. The method of claim 1 wherein a record is generated for each match.

14. The method of claim 1 wherein one record is generated for a plurality of matches.

15. The method of claim 1 further comprising associating at least one record with the text based data.

16. The method of claim 15 further comprising associating at least one record with particular portions of text based data.

17. The method of claim 15 further comprising storing at least one record and a link to the text based data in a database.

18. The method of claim 1 further comprising calculating the relevance of the text based data.

19. The method of claim 18 wherein calculating comprises counting the number of occurrences of a term from the predefined list in the text based data.

20. A method of converting unstructured data into structured data comprising:
reading a plurality of unstructured text messages or communications;
comparing said plurality of unstructured text messages or communications against a predefined list of terms;
generating a structured record if a term in a particular text message or communication matches a term in the predefined list, and deleting the particular text message or communication if a term in the predefined list does not match any term in the particular text message or communication; and
storing the records in a database.

21. The method of claim 20 wherein the predefined list includes categories of terms, and wherein the method further comprises grouping the records by the categories in the predefined list.

22. The method of claim 20 further comprising associating each generated record with the particular text message or communication.

23. The method of claim 20 wherein the categories include finance, accounting, or sales.

24. The method of claim 20 further comprising calculating the relevance of the text based data by counting the number of occurrences of a term from the predefined list in the text based data.

25. The method of claim 20 wherein the text based data are a plurality of emails.

26. The method of claim 20 further comprising converting audio to text based data.
